(19) United States
(12) Patent Application Publication
(10) Pub. No.: US 2020/0115141 A1
(43) Pub. Date: Apr. 16, 2020

(54) EMBLEM-BEARING INSULATOR FOR A BEVERAGE CONTAINER

(71) Applicant: KELLY OLSEN, DULUTH, MN (US)

(72) Inventor: KELLY OLSEN, DULUTH, MN (US)

(21) Appl. No.: 16/158,437

(22) Filed: Oct. 12, 2018

(51) Int. Cl. B65D 81/38; A47G 23/02; G09F 3/02

(52) U.S. Cl. CPC B65D 81/3876; A47G 23/0266; G09F 2003/0273; A47G 2023/0291; B65D 2313/02; G09F 3/02

(57) ABSTRACT

A system for insulating a beverage container may include an insulating layer with an outermost side covered in whole or in part with the loop component of a hook and loop fastening system, wherein the loop component may removably receive one or more emblems, patches, pockets, and the like.

### FIELD OF THE DISCLOSURE

The invention relates generally to a system and method for the insulation of a beverage container, and more particularly to an insulator that at least in part extends around a beverage container including a hook and loop fastening arrangement, wherein the outer surface of the insulator includes the loop component of the hook and loop fastening arrangement and removably receives emblems, patches, pockets, and the like.

### BACKGROUND

A number of methods are used today to insulate beverage containers. However, none of the prior methods is easily customizable to enable the display and use in conjunction with the insulated container of emblems, patches, pockets, and the like. Thus, there remains a need for an improved system and method for insulating beverage containers to permit the display and use of emblems, patches, pockets, and the like.

### SUMMARY

The present disclosure provides a system and method for insulating a beverage container, and more specifically, without limitation, to the use of an insulator adapted to easily removably receive on its outer surface emblems, patches, pockets, and the like.

Other benefits and advantages of the present disclosure will be appreciated from the following detailed description.

### DESCRIPTION OF THE DRAWINGS

Exemplary embodiments of an exemplary system and method for insulating a beverage container with an emblem-bearing insulator are shown in the accompanying drawings.

FIG. 1 is a perspective view of an exemplary beverage container and insulating system therefor, including a wrap assembly that extends around and about the beverage container.

FIG. 2 is a perspective view of the wrap assembly shown in FIG. 1.

FIG. 3 is a perspective view of the wrap assembly shown in FIGS. 1 and 2, including the removable positioning on the outer surface of the wrap assembly of emblems, patches, pockets, and the like.

### DETAILED DESCRIPTION

Embodiments of the invention and various alternatives are described. Those skilled in the art will recognize, given the teachings herein, that numerous alternatives and equivalents exist which do not depart from the invention. It is therefore intended that the invention not be limited by the description set forth herein or below.

One or more specific embodiments of the system and method will be described below. These described embodiments are only exemplary of the present disclosure. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, for clarity and convenience only, and without limitation, the disclosure (including the drawings) sets forth exemplary representations of only certain aspects of events and/or circumstances related to this disclosure. Those skilled in the art will recognize, given the teachings herein, additional such aspects, events and/or circumstances related to this disclosure, e.g., additional elements of the devices described; events occurring related to removably displaying emblems, patches, and the like; etc. Such aspects related to this disclosure do not depart from the invention, and it is therefore intended that the invention not be limited by the certain aspects set forth of the events and circumstances related to this disclosure.

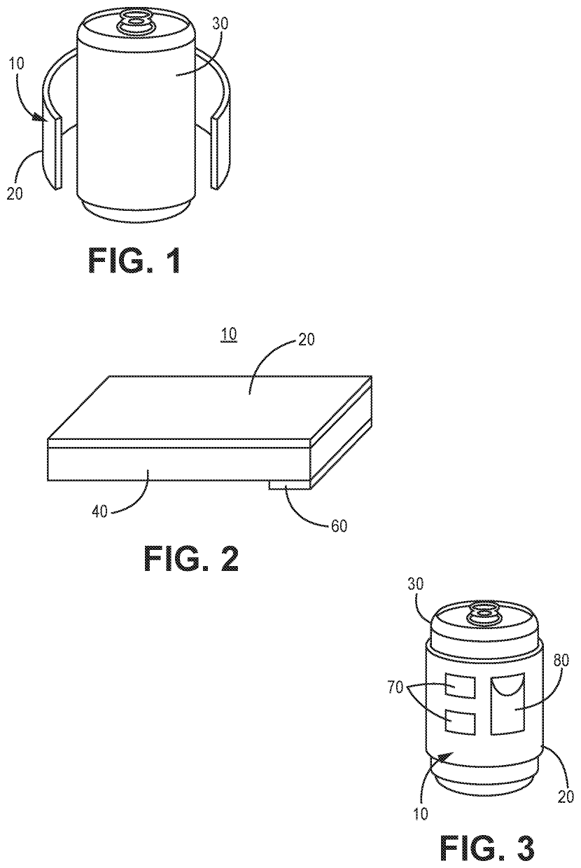

Turning now to the drawings, an exemplary system and method for insulating a beverage container is shown in FIG. 1. A wrap assembly 10 extends around and about a beverage container 30. The wrap assembly is removably secured about the beverage container using a hook and loop fastening system. See FIGS. 2 and 3. The outer surface 20 of the wrap assembly 10 comprises the loop component of the hook and loop fastening system. The entire outer surface 20 may be covered by such loop component. As shown in FIG. 2, such loop component may form a layer fixedly attached to an insulation layer 40, e.g., a layer of neoprene, foam, or other flexible insulating material. At an inside edge of the insulation layer 40, a strip 60 may be provided of the hook component of the hook and loop fastening system. In that way, as the wrap assembly 10 is positioned about a beverage container 30, the strip 60 will fasten to a portion of the outer surface 20. The strip 60 may comprise any size or shape.

The outer surface 20 of the wrap assembly may removably receive emblems or patches 70 that include hook component material on one side. In that way, a variety of emblems or patches may be provided that display a desired message to those viewing the insulated beverage container. Alternatively, or in addition, a pocket 80 similarly lined with hook material on an outer side may be provided for holding one or more small items, such as (by way of example) keys, a lighter, money, a driver's license or other form of identification, etc.

Although the beverage container shown in the drawings is a can, the invention is not so limited. Indeed, the wrap assembly described might be used on a glass, a mug, a bottle, or other form or size of beverage container.

In addition, although the wrap assembly in the Figures is shown as generally having a rectangular shape, the invention is not so limited. For example, the wrap assembly may have one or more angled edges to form a better fit with a glass having sloping sides (i.e., a larger diameter on the top as compared to the bottom). Also, by way of example, one end of the wrap assembly 10 including the strip 60 may be narrowed to fit through the handle of a mug. Other configurations of course are possible depending upon the circumstances involved in a particular application. In fact, because the hook strip 60 may be positioned anywhere on the outer surface 20 (i.e., the loop component), the wrap assembly 10 is adjustable in any number of ways.

The inside surface of layer 40 may be of any desired color or design. In one embodiment, a pocket or sleeve may be positioned on the inner surface to hold money, a form of identification, etc. Such a pocket or sleeve in one embodiment may not be readily observable to a casual onlooker.

Reference is made herein to a wrap assembly solely for convenience only. Indeed, other system configurations are possible. The insulating system may be of any form of insulating cooler for a can, bottle, mug, glass, etc., wherein at least a portion of the system's outer surface is covered by the loop component of a hook and loop fastening system. In that way, emblems, patches, pockets and the like including a hook component of a hook and loop fastening system may be removably displayed on the outer surface of the insulating system. In one embodiment, the insulating cooler may comprise sidewalls and a cover for the bottom of a beverage container. All or a portion of the sidewalls may be covered by loop component of a hook and loop fastening system. None, a portion, or all of the cover may be covered by loop component.

It should be understood that the foregoing description is only illustrative of the invention. Various alternatives and modifications can be devised by those skilled in the art having the benefit of this disclosure, without departing from the invention. Accordingly, the invention is intended to embrace all such alternatives, modifications and variances.

Certain exemplary embodiments of the disclosure may be described. Of course, the embodiments may be modified in form and content, and are not exhaustive, i.e., additional aspects of the disclosure, as well as additional embodiments, will be understood and may be set forth in view of the description herein. Further, while the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention.

What is claimed is:

1. An insulating system for a beverage container including:
(a) a flexible inner layer of insulating material including an inner surface and an outer surface;
(b) on the outer surface of the insulating material a layer of loop component from a hook and loop fastening system;
(c) on a portion of the inner surface of the insulating material a strip of hook component from a hook and loop fastening system; and
(d) one or more emblems removably fixed to an outermost side of the layer of loop component.

2. The insulating system described in claim 1, wherein the insulating material is one of foam or neoprene.

3. The insulating system of claim 1, wherein removably attached to the outermost side of the layer of loop component is a pocket.

4. The insulating system of claim 1, wherein the inner surface of the insulating material includes a sleeve or a pocket.

5. A beverage container insulator including a wrap comprising an inner layer of insulating material having inner and outer sides, and a hook and loop fastening system coupled to the wrap for securing the wrap about the beverage container, wherein the outer side of the insulating material is covered by the loop component of the hook and loop fastening system, and wherein the loop component includes one or more emblems removably positioned on the outermost surface thereof.

6. The sleeve described in claim 5, wherein the wrap includes an angled edge.

7. The sleeve described in claim 5, wherein the wrap includes a narrowed end for placement through the handle of a mug.

8. An insulating system for a beverage container including:
(i) a flexible inner layer of insulating material including an inner surface and an outer surface; and
(ii) on the outer surface of the insulating material a layer of loop component from a hook and loop fastening system.

9. The insulating system of claim 8, wherein the layer of loop component covers the entire outer surface of the insulating material.

10. The insulating system of claim 8, wherein the insulating system includes a cover for the bottom of the beverage container, and wherein the layer of loop component covers the entire outer surface of the insulating material except the cover.

11. The insulating system of claim 8, wherein a portion of hook component from a hook and loop fastening system is on a portion of the inner surface of the insulating material.

12. The insulating system of claim 8, wherein one or more emblems are removably fixed to an outermost side of the layer of loop component.

13. The insulating system of claim 8, wherein the insulating material is foam or neoprene.

14. The insulating system of claim 8, wherein the inner surface of the insulating material includes a sleeve or a pocket.
